(19) United States
(12) Patent Application Publication
(10) Pub. No.: US 2008/0205800 A1
(43) Pub. Date: Aug. 28, 2008

(54) TRANSPARENT BIAXIALLY ORIENTED POLYPROPYLENE FILM WITH LOW MOISTURE VAPOR AND OXYGEN TRANSMISSION RATE

(75) Inventors: Tien-Kuei Su, Somerset, NJ (US); Keunsuk P. Chang, North Kingstown, RI (US)

Correspondence Address: MORRISON & FOERSTER LLP, 1650 TYSONS BOULEVARD, SUITE 400, MCLEAN, VA, 22102, US

(73) Assignee: TORAY PLASTICS (AMERICA), INC., N. Kingstown, RI (US)

(21) Appl. No.: 12/039,495

(22) Filed: Feb. 28, 2008

Related U.S. Application Data
(60) Provisional application No. 60/903,841, filed on Feb. 28, 2007.

(51) Int. Cl. B32B 27/08; B29C 47/06; B29C 55/12; B65D 30/08

(52) U.S. Cl. 383/109; 428/523; 264/173.19; 383/113

(57) ABSTRACT

A laminate film comprising a polyetheramine resin-containing layer, an adhesion-promoting tie-layer, and a core layer comprising of high crystalline propylene homopolymer and crystalline Fischer-Tropsch wax with an optional amount of hydrocarbon resin which exhibits excellent transparency and oxygen and moisture barrier properties. The laminate film could further have additional layers such as a second polyolefin resin-containing layer, or combinations thereof.

### CROSS-REFERENCE TO RELATED APPLICATION

This application claims the benefit of U.S. Provisional Application Ser. No. 60/903,841, filed Feb. 28, 2007.

### FIELD OF INVENTION

This invention relates to a multi-layer biaxially oriented polypropylene film (BOPP) that includes novel blends of propylene homopolymer with crystalline Fischer-Tropsch waxes and optional hydrocarbon resins with a top layer of polyhydroxyaminoether polymer or other polar polymers.

### BACKGROUND OF INVENTION

Biaxially oriented polypropylene (BOPP) films used for packaging applications often perform multiple functions. For example, they may perform in a lamination to provide moisture and oxygen barrier. They may provide a heat sealable layer for bag forming and sealing, or a layer that is suitable for receiving an adhesive either by coating or laminating. Often they may provide a surface suitable for printing to display graphic designs.

In addition, for some packaging applications, it is desirable for the BOPP to have good moisture vapor and oxygen barrier properties as well as transparency. Metallization of BOPP via vacuum deposition of aluminum is a cost effective method to improve significantly the moisture and oxygen barrier properties of BOPP films. However, such a process renders the BOPP film opaque. Thus, for packaging applications that require transparency, metallized OPP is not suitable. For clear transparent BOPP film barrier improvement, coatings or coextruded layers of polar polymers can be applied to a BOPP substrate such as polyethylene vinyl alcohol (EVOH), polyvinyl alcohol (PVOH), or polyhydroxyaminoether (PHAE) or other polar polymers that demonstrate high oxygen barrier properties.

However, such polar materials while providing excellent oxygen gas barrier properties, often provide inadequate water vapor barrier properties since the polar nature of these polymers allow the polar water molecules to diffuse through them relatively easily. Moreover, in the case of EVOH and PVOH, exposure of these vinyl alcohol polymers in high humidity conditions shows a significant deterioration of gas barrier properties. PHAE materials, however, are more resistant to the loss of barrier properties under high humidity conditions. Without being bound to any theory, this is believed to be due to the aliphatic nature of EVOH and PVOH which makes them susceptible to swelling or plasticization when water is absorbed. However, the aromatic structure of PHAE resists water absorption and swelling and the higher Tg of PHAE due to its aromatic structure also inhibits water diffusion.

Polyvinylidene chloride coatings (PVDC), however, provide both oxygen and moisture vapor barrier improvements when applied to BOPP substrates; however, environmental issues surrounding the use of packaging have made the use of PVDC coatings in packaging structures unfavorable due to the potential generation of hazardous substances (e.g. HCl gas) when reprocessing or incinerating PVDC-containing materials. Coating OPP substrates with aluminum oxide (AlOx) or silicone oxide (SiOx) layers can significantly improve gas and moisture barrier properties while maintaining transparency; however, such coatings tend to be brittle and fail in flexible packaging applications due to cracking of the oxide layers during bag-forming and package handling damage. Such oxide coatings also tend to be relatively expensive.

Chlorotrifluoroethylene (CTFE) polymer films provide excellent moisture barrier properties but: 1) Do not provide significant oxygen barrier properties; 2) could suffer from potential hazardous by-products from incineration due to the halogenated polymer; 3) are very expensive materials which preclude their use in broad packaging applications. Thus, there continues to be a need for a cost-effective, environmentally safer, polyolefin-based transparent barrier film for both gas and moisture vapor.

Attempts to improve the moisture barrier of transparent OPP films in a cost-effective manner have often involved blending propylene homopolymer with waxes or hydrocarbon resins in the core layer of the multi-layer BOPP film. Without being bound by theory, the concept in this approach is that the low molecular weight wax or hydrocarbon resin migrates to and collects in the non-crystalline amorphous regions of the BOPP film, thus helping to block and prevent diffusion of oxygen and moisture.

Additionally, in the case of waxes, it is believed that the wax further migrates to the surface of the substrate and can form a contiguous layer which provides a barrier to moisture vapor. Thus, by using a combination of hydrocarbon and wax, two mechanisms can be exploited to improve moisture barrier properties.

This can further be improved by selecting high crystallinity content polypropylenes and crystalline waxes or hydrocarbon resins with narrow molecular weight distributions. However, while this approach can improve water vapor barrier, oxygen barrier properties are not as significantly improved. Moreover, particularly in the case of using waxes, these waxes have been known to migrate to the surface of the BOPP film where they are then very susceptible to plating-out or transferring to various surfaces of processing equipment such as rollers and causing appearance or operability defects. Also, since the BOPP films are often printed with inks for design graphics, the migration of the wax to the print surface interferes significantly with ink wet-out and adhesion, resulting in poor print quality. Moreover, as the wax is “lost” from the surface via these plate-out issues, barrier properties are compromised and degraded. Thus, there continues to be a need for a transparent barrier film with good processability and converting properties.

U.S. Pat. No. 5,500,282 describes the use of high crystalline content propylene homopolymer with an intermolecular stereoregularity greater than 93% mixed with “a moisture barrier improving amount of polyterpene resin.” This formulation provides an oriented film structure of improved water vapor transmission rate. However, such a structure provides little significant or useful improvement in oxygen barrier properties.

U.S. Pat. No. 5,667,902 describes the use of blending a high crystalline propylene homopolymer having an isotactic stereoregularity of greater than about 93%, with a second propylene homopolymer having an isotactic stereoregularity of from about 90% to about 93%, and a resin modifier wherein the resin modifier is hydrogenated hydrocarbon resin. However, such a structure provides little significant or useful improvement in oxygen barrier properties.

U.S. Pat. No. 6,503,611 describes the use of blends of propylene-based polymers with crystalline waxes as a cold seal release layer. Release properties are adequate; however, processability is an issue with the low molecular weight waxes causing 1) die build-up issues; 2) smoke generation; 3) tendency to stick to downstream rollers in tentering operations. Also, since the wax is a component of a relatively thin skin layer, there are no substantial improvements in moisture barrier or oxygen barrier properties.

U.S. Pat. No. 6,033,514 describes the use of multilayer biaxially oriented polypropylene films with improved moisture vapor transmission rates by formulating a core resin layer with an amount of crystalline wax. This core layer is then encapsulated by polyolefin cap layers to help prevent blooming of the wax to the surface and causing plate-out issues. However, the cap layers utilized by this patent are non-polar polyolefins and the wax readily migrates from the core layer into and through the cap layers and onto the surface of the cap layer. Thus, although the rate of wax migration may be more controlled, it still occurs nevertheless, and is still prone to the afore-mentioned plate-out issues. In addition, there is no significant or useful improvement in oxygen barrier properties.

U.S. Pat. No. 6,033,771 describes the use of waxes to improve moisture and oxygen barrier properties of multilayer BOPP films. In this invention, the wax is blended into a core layer and an intermediate cavitated layer between the core layer and surface layer is used to entrap the wax within its voids and prevent its migration to the surface, thus avoiding plate-out problems. However, the cavitation of the intermediate layer renders the invention opaque and is no longer transparent.

U.S. Pat. No. 5,141,801 describes the use of wax incorporated into a crystalline polyolefin layer for improved moisture barrier properties with an interior layer of EVOH to prevent migration of the wax through the surface. The EVOH also provides oxygen gas barrier properties to the film structure. However, the EVOH layer is susceptible to environmental humidity conditions and consequent loss of barrier properties. Thus, this patent recommends encapsulating the EVOH layer with a second wax-containing polyolefin blend layer to protect the EVOH from moisture diffusion. However, this second wax-containing layer in such multilayer structure means that the wax is free to migrate to its surface and continue to cause plate-out issues.

U.S. Pat. No. 7,163,727 describes the use of PHAE coatings or layers on polyolefin substrates for improved oxygen barrier properties. However, such a structure does not have significantly improved moisture barrier properties.

This invention seeks to avoid some of the disadvantages of the prior art films.

### SUMMARY OF THE INVENTION

We seek to address the above issues of transparent barrier biaxially oriented polypropylene-based films. Provided are films that balance the above attributes by adding a crystalline Fischer-Tropsch wax with an optional amount of hydrocarbon resin to a propylene homopolymer core layer or a blend of propylene homopolymer and propylene copolymers.

The propylene homopolymer used in the core layer preferably has a high crystalline content homopolymer with an isotactic index of 95% or greater. One surface of this core layer is then treated via a discharge treatment method to add polar functional groups and increase its surface energy; alternatively and preferably, an adhesion-promoting layer containing polar functional groups can be coextruded on one side of the core layer.

A PHAE layer is then applied to the treated surface or adhesion-promoting layer opposite the core layer. Other polar polymers may be contemplated as well such as EVOH or PVOH or blends thereof. The resulting film has excellent transparency, very good oxygen barrier properties, and good moisture barrier properties. In addition, the film exhibits no detrimental wax plate-out issues due to the polar PHAE layer acting as a barrier to the non-polar low molecular weight wax.

One embodiment is a laminate film including a polyetheramine (also known as epoxy-amine polymer or polyhydroxyamino-ether) resin-containing layer on a first polyolefin resin-containing layer. Preferably, the polyetheramine resin-containing layer is directly on the first polyolefin resin-containing layer and the first polyolefin resin-containing layer includes a tie-layer or adhesion promoting material.

The laminate further includes a second polyolefin resin-containing layer on the first polyolefin resin-containing layer. This second polyolefin resin-containing layer could be considered a core layer to provide the bulk strength of the laminate film. This second polyolefin resin layer includes a high crystalline propylene homopolymer with an amount of crystalline Fischer-Tropsch wax. Furthermore, the laminate could further include a third polyolefin resin-containing layer on the second polyolefin resin-containing core layer opposite the side with the first polyolefin resin-containing tie-layer. This third polyolefin layer could function as a heat sealable layer or could be formulated to improve winding properties, adhesion properties, or printing properties.

Preferably, the polyetheramine resin is a copolymer of bis-phenol A diglycidyl ether (BADGE) and resorcinol diglycidyl ether (RDGE) with ethanolamine while the first polyolefin resin-containing tie-layer includes a propylene homopolymer or copolymer grafted with maleic anhydride or a blend of propylene homopolymer or copolymer with a maleic-anhydride grafted propylene homopolymer or copolymer. Alternatively, the first polyolefin resin-containing tie-layer could also include various blends of ethylene propylene copolymers with ethylene polar terpolymers that provide good adhesion between the polyetheramine layer and propylene homopolymer or copolymer core layers. The PHAE layer provides excellent transparency and oxygen barrier properties and its polar nature inhibits the migration of waxes to its surface.

Preferably, the second polyolefin resin-containing layer includes a propylene homopolymer or copolymer. More preferable is a high isotactic index propylene homopolymer of 95% or greater (as measured by ¹³C NMR spectra) to act as the core or base layer of the laminate film. This high crystalline content homopolymer is also blended with an amount of Fischer-Tropsch high crystalline wax to improve further the moisture barrier properties of the laminate film. Additionally and optionally, an amount of hydrocarbon resin may be added to this layer as a processing aid to improve biaxial orientation of the laminate film structure and as a further aid to improving moisture barrier properties.

Preferably, the third polyolefin resin-containing layer includes a heat sealable polyolefin including polypropylene copolymers, terpolymers, polyethylene and combinations thereof. In another variation of the third polyolefin resin-containing layer, the heat sealable layer includes an antiblock component including amorphous silicas, aluminosilicates, sodium calcium aluminum silicate, a crosslinked silicone polymer, and polymethylmethacrylate. Alternatively, the third polyolefin resin-containing layer could also include a winding layer comprising a crystalline polypropylene or a propylene copolymer with ethylene or butene or blends thereof; and an inorganic antiblocking agent. The winding layer could be a discharge treated winding layer having a surface for lamination or coating with adhesives or printing with inks. Preferably, the winding layer includes an antiblock component including amorphous silicas, aluminosilicates, sodium calcium aluminum silicate, a crosslinked silicone polymer, and polymethylmethacrylate.

Another embodiment is a method for flexible packaging including obtaining a laminate film including a polyetheramine resin-containing layer on a first polyolefin resin-containing tie-layer; a second polyolefin resin-containing layer of high crystalline polypropylene and crystalline Fischer-Tropsch wax; and surrounding a product by the laminate film. Preferably, the product is a food product.

In yet another embodiment, this invention provides biaxially oriented polyolefin multi-layer films with a skin of polyetheramine and core layers of high crystalline polypropylene and Fischer-Tropsch waxes to enhance barrier and printing properties for flexible packaging purposes. An additional embodiment provides laminate structures of polyolefin layers of high crystalline polypropylene and Fischer-Tropsch waxes and polyetheramine layers for barrier applications in flexible packaging.

Another embodiment is a laminate film including a polar polymer other than polyetheramine. Other polar polymers such as EVOH or PVOH can be contemplated as well which provide excellent oxygen barrier properties as well as the polar nature required to inhibit blooming of the moisture barrier-providing waxes to the surfaces of the laminate which can cause other processing or converting issues.

The described methods and films improve the oxygen and moisture barrier properties of biaxially oriented films resulting in a high barrier packaging film with excellent gas barrier properties and transparency. The methods and films help solve the problem associated with the prior art of surface defects, processability issues, and limitations of oxygen and moisture barrier properties.

The laminate film of the invention may include at least a 2-layer laminate film wherein the core layer or substrate layer is an oriented film, either monoaxially or biaxially, the preferred being biaxially oriented. This core or substrate layer may include polyolefins such as propylene homopolymer, ethylene homopolymer, copolymers of propylene and ethylene, copolymers of butene and propylene, terpolymers of ethylene, propylene and butene, or blends thereof combined with an amount of tie-layer or adhesion-promoting resin. Particularly preferred is a blend of high crystalline propylene homopolymer blended with a maleic anhydride-grafted propylene homopolymer or copolymer. Alternatively preferred is a blend of high crystalline propylene homopolymer or copolymer with ethylene polar terpolymers that provide good adhesion between the polyetheramine layer and propylene homopolymer or copolymer core layers. Additionally, an amount of crystalline Fischer-Tropsch wax is blended into this layer.

A skin layer of polyetheramine may be applied contiguously upon at least one of the surfaces of the substrate layer. The method of applying the polyetheramine layer to the substrate layer can be of various means well known in the art, such as solution coating an aqueous solution of the polyetheramine resin onto the substrate layer by means of a coating roll (e.g. gravure roll) or other coating means, and drying of the coating.

In particular, a cost effective method of applying the polyetheramine aqueous solution is by means of a gravure coating roll via an in-line coating method whereby the coating station is placed “in-line” with the film-making line. In this configuration, the coating station is placed between the machine direction orientation section and the transverse direction orientation section of a sequential biaxial orientation line. Thus, the polyetheramine coating is applied on the tie-layer surface of the substrate after machine direction orientation of the substrate but before the transverse direction orientation of the substrate. The transverse direction orientation section's preheat ovens effectively act as a drier to remove the solvent (water in this case); leaving the polyetheramine polymer adhered to the substrate.

The substrate is stretched in the transverse direction, thus completing the biaxial orientation process; the amorphous nature of the polyetheramine polymer is particularly well-suited to stretching as well, without cracking or loss of adhesion to the substrate. In the case of a simultaneous biaxial orientation process which does not have a separate machine direction orientation section, the in-line coating station can be placed between the casting section and the orientation oven. Other polar polymer aqueous solutions can be contemplated as well, such as solution grade EVOH and PVOH or blends thereof.

Another method is extrusion coating a polyetheramine onto the tie-layer portion of the substrate whereby a molten stream of the polyetheramine is coated onto the substrate by means of a die. Yet another method is to coextrude the polyetheramine along with the substrate tie-layer or tie-resin modified core layer through a compositing die whereupon the molten multilayer film structure is quenched upon a chilled casting roll system or casting roll and water bath system. It can also be contemplated to extrude or coextrude a layer of extrusion grade EVOH or PVOH or blends thereof as the polar polymer layer.

Optionally, an additional layer of a heat sealable surface or a winding surface containing antiblock and/or slip additives for good machinability and low coefficient of friction (COF) can be disposed on the polyolefin tie-resin modified substrate layer, opposite the side with the polyetheramine layer. Additionally, if this additional layer is used as a winding surface, its surface may also be modified with a discharge treatment to make it suitable for laminating or converter applied adhesives and inks.

### DETAILED DESCRIPTION OF THE INVENTION

Described are formulations that provide excellent high moisture vapor barrier properties without incurring attendant processing issues with wax blooming to the surface and causing poor printability. Also described are films that provide improved oxygen gas barrier properties, even under high humidity conditions.

This invention relates to a multi-layer biaxially oriented polypropylene film (BOPP) that includes novel blends of propylene homopolymer with crystalline Fischer-Tropsch waxes and optional hydrocarbon resins with a top layer of polyhydroxyaminoether polymer or other polar polymers.

U.S. Pat. No. 7,163,727 and U.S. application Ser. No. 11/107,928 disclose polyetheramine-containing laminate film structures for flexible packaging applications. The disclosures of these patent applications are incorporated herein by reference.

U.S. application Ser. No. 11/416,385 discloses a tie-layer resin blend formulation which uses ethylene polar terpolymers which are different from well-known maleic anhydride-grafted propylene-based homopolymers or copolymers. The disclosure of this provisional patent application is incorporated herein by reference.

It has been found that by using polyetheramine polymers (aka epoxy-amine polymer, polyhydroxy amino ether) in a contiguous layer formed upon a polyolefin or polyester film substrate results in a multilayer film structure exhibiting superior gas barrier properties and an exceptionally high surface energy. Unlike EVOH or related materials such as PVOH, however, no tie-layer or adhesion promoting materials such as anhydride-grafted polyolefins are required to bond the polar layer to a discharge-treated (i.e. corona, flame, or plasma treatment) polyolefin or amorphous copolyesters; nor are primers required to bond to a polyethylene terephthalate film substrate.

Adequate adhesion of the polyetheramine is found without the need of such intermediate adhesion promoting layers or tie resins, so long as the substrate has a sufficiently high surface energy such as can be obtained via discharge treatment methods that are well-known in the industry. Thus, product cost can be reduced as expensive tie-layers and capital for specialty multi-layer compositing dies can be avoided.

Moreover, because of the amorphous nature of polyetheramine, biaxial orientation of a layer of polyetheramine upon the polyolefin or polyester substrate is easily achieved, with no attendant cracking or peeling of the polyetheramine under stretching forces and temperatures. In addition, because of the high hydroxyl content of the polyetheramine composition, such a layer's surface energy is sufficiently high enough that no discharge-treatment method is required post-film-forming. This inherently high surface energy makes it readily suitable as a printing, metallizing, coating, or laminating surface.

Nevertheless, discharge-treating of the polyetheramine surface can enhance further the bonding, printing, or metallizing performance of this material. However, like EVOH, polyetheramine is sensitive to humidity in that high humidity conditions can negatively impact its gas barrier properties. Thus, like EVOH, polyetheramine should be protected against humidity effects if used as part of a multilayer film or laminate, whereby the polyetheramine layer should be buried between other layers.

Nevertheless, although adequate adhesion of the polyetheramine layer has been found using processing methods such as off-line coating of polyetheramine aqueous solutions to a discharge-treated polyolefin substrate without requiring the use of tie-layer or adhesion-promoting materials, it has been found that when using in-line coating methods in particular, discharge-treatment of the substrate prior to coating is not always sufficient to ensure adequate adhesion of the polyetheramine layer to the polyolefin substrate layer.

Even though a discharge-treatment method is employed prior to the in-line coating station (i.e. after machine direction orientation in a sequential biaxial orientation method but prior to the in-line coating station) and surface energies of 40 dyne-cm/cm or more are obtained prior to coating, it has been found that after the transverse orientation portion of the process, the polyetheramine layer can be easily delaminated from the polyolefin substrate.

Without being bound to any theory, it is possible that during the transverse orientation process, two phenomena are occurring: 1) the surface area of the substrate greatly increases, thus greatly reducing the per-unit area density of the active treated sites for the polyetheramine polymers to adhere adequately; 2) during the preheating and stretching sections of the transverse direction orientation oven, the active treated sites and functional groups imparted by the discharge treatment method, migrate from the surface of the polyolefin substrate into the substrate itself, thus decreasing the amount of active sites for adhesion. Thus, another method may be employed to help maintain robust adherence of the polyetheramine layer to the substrate during and after the orientation process.

Phenoxy-type thermoplastics, including polyhydroxy ether, polyhydroxy ester ethers, and polyhydroxy amino ethers, are described in the literature such as Polymer Preprints, 34(1), 904-905 (1993). Polyhydroxy amino ether (PHAE), also called polyetheramine, is an epoxy-based thermoplastic. Its repeating unit is composed of aromatic ether and ring or linear amine in the backbone chain, and hydroxyl groups in the pendants from the opening of the epoxy groups. The basic PHAE is made of bis-phenol A diglycidyl ether (BADGE) and ethanol amine. Property modification can be achieved by copolymerization of BADGE and resorcinal diglycidyl ether (RDGE) with ethanol amine which improves gas barrier properties. The amount of the RDGE component in the PHAE copolymer determines the effectiveness of the gas barrier properties. Increasing the percentage by weight of the RDGE component in the copolymer, further improves the oxygen gas barrier properties as shown in Table A (from Dow Chemical Company technical report “Building BLOX®—New Thermoplastic Adhesive and Barrier Resins” by Terry Glass and Marie Winkler, 2001). However, PHAE is not an effective moisture barrier material due to its polar nature and subsequent diffusion of water vapor molecules.

TABLE A

| % RDGE | O2TR (cc/m²/day |
|---|---|
| 25 | 5.9 |
| 30 | 3.1 |
| 50 | 0.62 |

U.S. Pat. No. 5,275,853 describes the composition and process of making polyetheramine. The polyetheramine for the laminate film of this invention could be made by the process of U.S. Pat. No. 5,275,853 are by other known methods.

In one embodiment of the invention, the laminate film includes: a mixed resin layer including an isotactic polypropylene or ethylene-propylene copolymer resin layer blended with an amount of maleic anhydride-grafted propylene homopolymer or maleic anhydride-grafted ethylene propylene copolymer or an ethylene polar terpolymer or blends thereof, with one side discharge-treated for high surface energy suitable for printing or coating; an isotactic high crystalline propylene homopolymer core layer blended with an amount of crystalline Fischer-Tropsch wax disposed on one side of the mixed resin layer, opposite the discharge-treated side; a heat sealable ethylene-propylene-butene terpolymer layer coextruded onto one side of the core layer opposite the mixed resin layer side; and a polyetheramine layer coated onto the discharge-treated surface of the mixed resin layer.

The polypropylene resin core layer is a crystalline polypropylene of a specific isotactic content and can be uniaxially or biaxially oriented. Crystalline polypropylenes are generally described as having an isotactic content of about 90% or greater. Preferably, in order to impart improved moisture barrier properties, a high crystalline polypropylene is recommended, generally described as having an isotactic index of 95% or greater. Suitable examples of high crystalline polypropylenes for this invention are Fina 3270 and ExxonMobil PP4052. These resins also have melt flow rates of about 0.5 to 5 g/10 min, a melting point of about 163-167° C., a crystallization temperature of about 108-126° C., a heat of fusion of about 86-110 J/g, a heat of crystallization of about 105-111 J/g, and a density of about 0.91.

The isotactic index of these high crystalline polypropylene grades are about 97% as measured by ¹³C NMR spectra of the resins dissolved in a 1,2,4-trichlorobenzene solution at 130° C. and obtaining the percent isotacticity from the intensity of the isotactic methyl group at 21.7 ppm vs. the total isotactic and atactic methyl groups from 22-19.4 ppm. The core resin layer is typically 5 μm to 50 μm in thickness after biaxial orientation, preferably between 10 μm and 25 μm, and more preferably between 12.5 μm and 17.5 μm in thickness.

Additionally, a small amount of inorganic antiblocking agent may be optionally added up to 1000 ppm to this resin layer. Preferably 300-500 ppm of antiblock may be added. Suitable antiblock agents include those such as inorganic silicas, sodium calcium aluminosilicates, crosslinked silicone polymers such as polymethylsilsesquioxane, and polymethylmethacrylate spheres. Typical useful particle sizes of these antiblocks range from 1-12 um, preferably in the range of 2-6 um.

The core resin layer also include an amount of crystalline Fischer-Tropsch wax in an amount of about 2-20 wt. % of the core layer. Preferably the amount is between about 5-15 wt %, and more preferably between about 6-12 wt % of the core layer. A suitable crystalline Fischer-Tropsch wax is a grade available from Sasol Wax—C80—which is characterized as having a congealing point of 78-83° C., drop melting point of 88° C., kinematic viscosity at 100° C. of 0.4 cSt, needle penetration at 25° C. of 6 (0.1 mm), needle penetration at 65° C. of 66 (0.1 mm), and oil content of maximum 0.75 mass %.

An optional amount of hydrocarbon resin can also be included in the core layer to aid in orientation stretching of the high crystalline polypropylene to reduce unstretched or uneven stretch marks and film breaks.

Suitable loadings of hydrocarbon resin of up to 10 wt % of the core layer can be used. Preferably, 10 wt % hydrocarbon resin in the core layer alleviates any processing or stretching issues found with the high crystalline polypropylenes and also helps further in reducing moisture transmission. A suitable hydrocarbon resin grade is a masterbatch from ExxonMobil known as PA609A which is a 50 wt % hydrocarbon resin of the masterbatch in a polypropylene carrier resin. This hydrocarbon resin is a polydicyclopentadiene resin. The masterbatch has a melt flow rate of 28 g/10 min at 230° C., density of 0.975, and melting point of 151° C.

The core layer can also include a blend with a maleic anhydride-grafted propylene homopolymer or maleic anhydride-grafted ethylene-propylene copolymer. Preferably, this mixed resin core layer includes a blend of propylene homopolymer and maleic anhydride-grafted propylene polymer. This mixed resin blend layer acts as the “tie-layer” to bond effectively the polyetheramine layer to the propylene homopolymer core layer. More preferably, though, is to coextrude a discrete layer on one side of the high crystalline core layer with either a maleic anhydride-grafted propylene homopolymer or ethylene-propylene copolymer.

A suitable formulation for this tie resin layer is a blend of Total EOD04-37 mini-random propylene homopolymer or Total 3576X propylene homopolymer with Mitsui Admer QF551A maleic anhydride-grafted ethylene propylene copolymer. Mitsui Admer QF500A maleic anhydride-grafted propylene homopolymer can also be used. The amount of anhydride in these grafted polymers is about 0.12% to 0.15%. The maleic anhydride-grafted propylene-containing polymers can contain some ethylene-propylene rubber or it may not. The amount of maleic anhydride-grafted propylene-containing polymer in the mixed resin blend is about 5% to 100%, preferably 10-50%, and more preferably 15-30%.

Alternatively, the mixed resin tie-layer can include a blend of: ethylene-propylene copolymer and ethylene polar terpolymers such as ethylene-butyl acrylate-maleic anhydride copolymer and/or ethylene-glycidal methacrylate-methyl acrylate copolymer. The ethylene-propylene copolymer (EP copolymer) can be of any number of commercially available EP copolymers, ranging from 1% ethylene to about 70% ethylene.

Suitable EP copolymers suitable for this tie-layer blend are for example, Total 8473 (a nominal 4% ethylene content EP copolymer) and Lanxess Buna EP-T-2070-P (a nominal 65-71% ethylene content EP copolymer). Preferably, the EP copolymer component of this tie-layer blend is in the 3-6% ethylene content range. Suitable ethylene polar terpolymers for this tie-layer blend are such as those available from Arkema: LOTADER 4210 (an ethylene-butyl acrylate-maleic anhydride terpolymer) or LOTADER AX8900 (an ethylene-glycidal methacrylate-methyl acrylate terpolymer). LOTADER 4210 is a copolymer of about 91% ethylene, 6% butyl acrylate, and 4% maleic anhydride; it should be noted that LOTADER 4210 is not a grafted maleic anhydride polymer like Admer QF551A or QF500A. LOTADER AX8900 is a copolymer of about 67% ethylene, 8% glycidal methacrylate, and 25% methyl acrylate. The blending ratio of this alternate tie-layer formulation is 0-95% EP copolymer to 100%-5% of the ethylene polar terpolymer respectively. Preferred is about 10% to 50% of the ethylene polar terpolymer, more preferred is 20-40% of the ethylene polar terpolymer, with the respective balance made up of the EP copolymer.

The mixed resin tie-layer can be coextruded on one side of the core layer having a thickness after biaxial orientation between 0.1 and 5 μm, preferably between 0.5 and 3 μm, and more preferably between 0.5 and 1.0 μm. For the mixed resin layer blend, it is also contemplated to add an antiblock to aid in film handling. A small amount of inorganic antiblocking agent may be optionally added up to 1000 ppm to this resin layer. Preferably 300-500 ppm of antiblock may be added. Suitable antiblock agents include those such as inorganic silicas, sodium calcium aluminosilicates, crosslinked silicone polymers such as polymethylsilsesquioxane, and polymethylmethacrylate spheres. Typical useful particle sizes of these antiblocks range from 1-12 um, preferably in the range of 2-6 um.

The mixed resin tie-layer can be surface treated with a corona-discharge method, flame treatment, atmospheric plasma, or corona discharge in a controlled atmosphere of nitrogen, carbon dioxide, or a mixture thereof. The latter treatment method in a mixture of CO₂ and N₂ is preferred. This method of discharge treatment results in a treated surface that includes nitrogen-bearing functional groups, preferably 0.3% or more nitrogen in atomic %, and more preferably 0.5% or more nitrogen in atomic %. This treated mixed resin layer can then be metallized, printed, coated, or extrusion or adhesive laminated. Preferably, it is coated with a layer of polyetheramine.

A heat sealable layer or non-heat sealable layer may be coextruded with the core layer opposite the mixed resin layer having a thickness after biaxial orientation between 0.2 and 5 μm, preferably between 0.6 and 3 μm, and more preferably between 0.8 and 1.5 μm. The heat sealable layer may contain an anti-blocking agent and/or slip additives for good machinability and a low coefficient of friction in about 0.05-0.5% by weight of the heat-sealable layer. The heat sealable layer will be a copolymer of propylene, either ethylene-propylene or butylene-propylene, and preferably include a ternary ethylene-propylene-butene copolymer.

A suitable heat sealable terpolymer resin is Sumitomo SPX78H8. If the film includes a non-heat sealable, winding layer, this layer will include a crystalline polypropylene with anti-blocking and/or slip additives or a matte layer of a block copolymer blend of polypropylene and one or more other polymers whose surface is roughened during the film formation step so as to produce a matte finish on the winding layer. Preferably, the surface of the winding layer is discharge-treated to provide a functional surface for lamination or coating with adhesives and/or inks.

The coextrusion process includes a three-layered compositing die. The polymer core layer is sandwiched between the mixed resin tie-layer and the heat sealable or winding layer. The three layer laminate sheet is cast onto a cooling drum whose surface temperature is controlled between 20° C. and 60° C. to solidify the non-oriented laminate sheet. The non-oriented laminate sheet is stretched in the longitudinal direction at about 135 to 165° C. at a stretching ratio of about 4 to about 5 times the original length and the resulting stretched sheet is cooled to about 15° C. to 50° C. to obtain a uniaxially oriented laminate sheet. The uniaxially oriented laminate sheet is introduced into a tenter and preliminarily heated between 130° C. and 180° C., and stretched in the transverse direction at a stretching ratio of about 7 to about 12 times the original length and then heat set to give a biaxially oriented sheet. The biaxially oriented film has a total thickness between 6 and 40 μm, preferably between 15 and 20 μm.

The polyetheramine layer is aqueous solution-coated onto the mixed resin tie-layer side of the laminate film structure formed by coextrusion. The polyetheramine polymer is preferably 10-70% RDGE comonomer content, more preferably 30-50% RDGE comonomer content. The % solids of the aqueous solution is from 10-50%, preferably 15-40%, and more preferably 25-35% with a viscosity of less than 50 cps. After drying, the dry coating weight of the polyetheramine layer is 0.3-5 mg/in², preferably 0.5-3.0 mg/in², and more preferably 0.6-1.5 mg/in².

Suitable types of polyetheramine can be obtainable from Dow Chemicals under the tradename “BLOX®” or from ICI Packaging Coatings under the tradename “OXYBLOC®.” In particular, BLOX® 5000 series grade is suitable for solution coating which has an RDGE comonomer content of 50% in the polyetheramine polymer. ICI's polyetheramine coating grade OXYBLOC® 670C1370 is also suitable and can be made available with RDGE comonomer content of 30%, 40%, and 50% or other amounts. The resulting clear film was tested for gas barrier properties and adhesion of the coating to the polypropylene substrate.

The aqueous coating can be applied either “in-line” or “out-of-line.” In an “in-line” coating, the coating station is located after the machine direction stretching process of a monoaxial or biaxial orientation process and dried in a drying oven or using the tenter oven preheating zones as a dryer. In the case of biaxial orientation, the coated monoaxially stretched film is then stretched in the transverse direction. An advantage of this process is that the orientation and coating of the invention can be essentially done in one processing step.

It is often beneficial to in-line discharge treat the monoaxial substrate prior to the coating station in order that the aqueous solution adequately “wets” the substrate surface for consistent coating weight, drying, and appearance. In an “out-of-line” coating process, the finished monoaxial or biaxial film is wound up in a roll form, and is mounted on a separate coating machine. Again, the monoaxial or biaxial film substrate should have the desired surface for coating with the polyetheramine solution discharge-treated in order that the solution adequately wets the surface. This separate coating line will then apply the solution, dry it, and rewind the finished product. The preferred method to coat in this embodiment is via the in-line coating process. In this case, the use of the mixed resin tie-layer is most advantageous to improve adhesion of the polyetheramine to the propylene-based resin substrate.

In out-of-line coating, the use of the mixed resin tie-layer was not necessary for adequate bonding of the polyetheramine to the propylene-based substrate so long as surface discharge-treatment of the substrate was adequate for the aqueous solution to wet-out. However, it was found that surface discharge-treating of the monoaxially stretched propylene-based substrate in the in-line process did not provide adequate adhesion of the polyetheramine to the substrate; however, the addition of a polar additive component such as maleic anhydride-grafted EP copolymer or ethylene polar terpolymer provided excellent adhesion of the polyetheramine to the substrate.

The polyetheramine resin can also be extrusion-coated onto the polymer substrate rather than solution-coated. Dow Chemical BLOX® grades for extrusion-coating that are suitable include but are not limited to BLOX® 4000 series and 0000 series. Similar to the solution-coating method, the extrusion-coating can be done either in-line—whereby the extrusion coating station is located after the first direction stretching process onto the monoaxially oriented film—or out-of-line whereby the extrusion-coating process is done on a separate machine onto the monoaxially or biaxially stretched substrate. It may also be desirable for the substrate to have the surface designated for coating to be discharge-treated in order that adequate adhesion of the BLOX® resin is obtained and to contain a tie-layer resin component or layer.

The polyetheramine layer may also be applied via coextrusion with the substrate layer. In this case, a compositing die is used to combine the melt streams of the polyetheramine extrudate with the substrate extrudate which is either a polyolefin of polyester. In this case, no discharge-treatment of the substrate is necessary as enough intermolecular mixing at the interface of the polyetheramine extrudate and substrate extrudate assures adequate bonding of the two layers.

However, it may be beneficial to ensure adequate adhesion by adding the tie-layer blend mixtures of maleic anhydride-grafted polyolefins or ethylene polar terpolymers. This coextrudate can then be cast onto a chill roll, quenched, then monoaxially or biaxially stretched into the final film product. The coextruded polyetheramine skin resin layer in this case has a thickness between 0.2 and 2 μm, preferably between 0.5 and 1.5 μm, more preferably 0.75-1 um, after biaxial orientation.

This invention will be better understood with reference to the following examples, which are intended to illustrate specific embodiments within the overall scope of the invention.

### EXAMPLE 1

A 3-layer coextrusion article including a core layer of a high crystalline polypropylene resin upon one side is coextruded a mixed resin tie-layer of 30 wt % Admer QF551A maleic anhydride-grafted EP copolymer and 70 wt % Total EOD04-37 polypropylene resin and, upon the side of the core layer opposite the mixed resin layer, a layer of a terpolymer sealant is disposed, was coated in-line with a solution of polyetheramine resin including 50 wt % RDGE, upon the mixed layer surface opposite the core layer. The total thickness of this film substrate after biaxial orientation is nominal 80G or 0.8 mil or 20 μm. The thickness of the respective mixed resin tie-layer and sealant skin layers after biaxial orientation is nominal 4G (1 μm) and 6G (1.5 μm).

The core includes 94 wt % high crystalline polypropylene Total 3270 and 6 wt % of the core layer of Sasol C80 crystalline Fischer-Tropsch wax. The thickness of the core layer after biaxial orientation is nominal 70G (17.5 μm). The mixed resin tie-layer and core layer is melt extruded at 450-550° F. The sealant layer includes an ethylene-propylene-butylene terpolymer such as Sumitomo SPX78H8 and 4000 ppm of an inorganic antiblock additive such as Toshiba TOSPEARL 120, a crosslinked silicone polymer of nominal 2.0 um particle size and is melt extruded at 400-480° F. The 3-layer coextrudate was passed through a flat die to be cast on a chill drum of 100-180° F. The formed cast sheet was passed through a series of heated rolls at 210-270° F. with differential speeds to stretch in the machine direction (MD) from 4 to 6 stretch ratio.

The monoaxially stretched substrate was in-line coated with the polyetheramine via a gravure roll with an OXYBLOC® 6701370 series aqueous solution, which has about 50 wt % co-monomer of RDGE. The OXYBLOC® solution includes the polyetheramine polymer dispersed in water. The % solid in water was about 30% and the solution viscosity less than 50 cps. This was followed by transverse direction (TD) stretching from 8 to 10 stretch ratio in the tenter oven at 310-350° F. The OXYBLOC®-coated substrate was passed through the transverse orientation oven which acted as a drying oven to achieve a dry coating weight of about 0.4 mg/in² or about 0.5 um in thickness. The dried coating had a T_{g} ranging from 50 to 95° C. The coated and dried resultant clear film was tested for adhesion properties of the polyetheramine layer to the substrate. After transverse stretching, the film was heat-set to minimize shrinkage and was treated via corona discharge treatment on the coated side. The film was wound into roll form. The film was then tested for appearance, haze, barrier properties, and coefficient of friction (COF).

### EXAMPLE 2

A process similar to Example 1 was repeated except that the core resin layer includes a blend of 74 wt % Total 3270, 6 wt % Sasol C80 Fischer-Tropsch wax and 20 wt % ExxonMobil PA609A hydrocarbon masterbatch (effective hydrocarbon amount 10 wt %). The film was tested for properties as in Example 1.

### COMPARATIVE EXAMPLE 1

A process similar to Example 1 was repeated except that the core resin layer includes 100 wt % of a conventional propylene homopolymer ExxonMobil PP4472 of ca. 93% isotactic index via ¹³C NMR spectra; no Fischer-Tropsch wax was added; and no PHAE coating applied. The resultant clear film was then tested for properties.

### COMPARATIVE EXAMPLE 2

A process similar to Example 1 was repeated except that the core resin layer includes a blend of 80 wt % Total 3270 high crystalline polypropylene and 20 wt % ExxonMobil PA609A hydrocarbon masterbatch (i.e. 10 wt % active hydrocarbon resin). No Fischer-Tropsch wax was added and no PHAE coating applied. The resultant clear film was then tested for properties.

### COMPARATIVE EXAMPLE 3

A process similar to Comparative Example 1 was repeated except that a PHAE coating was applied. After drying, the PHAE thickness was nominal 1.25 μm thick. The resultant clear film was then tested for properties.

### COMPARATIVE EXAMPLE 4

A process similar to Comparative Example 2 was repeated except that a PHAE coating was applied. After drying, the PHAE thickness was nominal 1.25 μm thick. The resultant clear film was then tested for properties.

### COMPARATIVE EXAMPLE 5

A process similar to Example 1 was repeated except that no PHAE coating was applied. The resultant clear film was then tested for properties.

The properties of the Examples and Comparative Examples (“CEx.”) are shown in Tables 1 and 2.

TABLE 1

| | Core Layer Composition wt % | | | | PHAE | | | |
|---|---|---|---|---|---|---|---|---|
| | | | F- | | Coating | | | |
| | | HCPP | T | HCR | thickness | Haze | MVTR | O2TR |
| Sample | Homo-PP4772 | 3270 | Wax | MB | (um) | (%) | g/100 in²/day | cc/100 in²/day |
| Ex. 1 | 0 | 94 | 6 | 0 | 0.5 | 2.2 | 0.17 | 2.5 |
| Ex. 2 | 0 | 74 | 6 | 20 | 0.5 | 2.3 | 0.12 | 2.1 |
| CEx. 1 | 100 | 0 | 0 | 0 | 0 | 2.1 | 0.38 | 182 |
| CEx. 2 | 0 | 80 | 0 | 20 | 0 | 2.2 | 0.20 | 94 |
| CEx. 3 | 100 | 0 | 0 | 0 | 1.25 | 2.5 | 0.38 | 0.67 |
| CEx. 4 | 0 | 80 | 0 | 20 | 1.25 | 2.7 | 0.21 | 0.65 |
| CEx. 5 | 0 | 94 | 6 | 0 | 0 | 2.3 | 0.18 | 90 |

TABLE 2

| | Core Layer | | | | | | | | | | |
|---|---|---|---|---|---|---|---|---|---|---|---|
| | Composition wt % | | | | | | | | | | |
| | | | F- | | PHAE Coating | Wetting Tension | Printability | COF | | | |
| | Homo- | HCPP | T | HCR | thickness | A-side | A-side | A/A | | B/B | |
| Sample | PP4772 | 3270 | Wax | MB | (um) | dyne/cm | 1-5, 5 = best | st | dy | st | dy |
| Ex. 1 | 0 | 94 | 6 | 0 | 0.5 | 44 | 4.0 | >1.0 | >1.0 | 0.33 | 0.29 |
| Ex. 2 | 0 | 74 | 6 | 20 | 0.5 | 44 | 4.0 | >1.0 | >1.0 | 0.29 | 0.24 |
| CEx. 1 | 100 | 0 | 0 | 0 | 0 | 41 | 4.0 | 0.85 | 0.72 | >1.0 | >1.0 |
| CEx. 2 | 0 | 80 | 0 | 20 | 0 | 41 | 4.0 | 0.75 | 0.61 | 0.65 | 0.54 |
| CEx. 3 | 100 | 0 | 0 | 0 | 1.25 | 44 | 4.0 | >1.0 | >1.0 | >1.0 | >1.0 |
| CEx. 4 | 0 | 80 | 0 | 20 | 1.25 | 44 | 4.0 | >1.0 | >1.0 | 0.68 | 0.54 |
| CEx. 5 | 0 | 94 | 6 | 0 | 0 | 38 | 2.5 | 0.37 | 0.29 | 0.34 | 0.29 |

As Table 1 shows, Comparative Example 1 (CEx 1), which is a control film using 100 wt % PP4772 propylene homopolymer as the core layer, had MVTR and O2TR barrier properties that were typical for a 0.80 mil thick BOPP film. Transparency was good as indicated by the low haze number. CEx. 2 shows an improvement in MVTR and O2TR barrier properties by using a core layer blend of high crystalline polypropylene (HCPP) and hydrocarbon resin (HCR) while maintaining good transparency. CEx. 5 shows incrementally better barrier improvements to CEx. 2, where the core layer is a blend of HCPP and Fischer-Tropsch wax (F-T wax).

Table 1 CEx. 3 and CEx. 4 are similar to CEx. 1 and CEx. 2 except that they were respectively coated in-line with a layer of polyhydroxyamine ether (PHAE). MVTR barrier properties remain the same as in their respective uncoated counterparts, but O2TR barrier properties are significantly improved. Transparency is still good as indicated by haze values.

Example 1 (Ex. 1) in Table 1 is similar to CEx. 5 except that it was coated in-line with a layer of PHAE, although a thinner layer than that of CEx. 3 and CEx. 4. MVTR barrier is similar to CEx. 5, but O2TR is significantly improved. Since the PHAE layer is thinner, the O2TR barrier is not as low as that of CEx. 3 and CEx. 4, but Ex. 1 still has a very good O2TR barrier, comparable to metallized BOPP films, and far superior to CEx. 1, CEx. 2, and CEx. 5. Transparency is incrementally improved over CEx. 3 and CEx. 4 due to the thinner coating.

Ex. 2 in Table 1 uses as a core layer blend of HCPP, HCR, and F-T wax. MVTR barrier is significantly improved versus Ex. 1, CEx. 1, CEx. 2, CEx. 3, CEx. 4, and CEx. 5 by ca. 29% to 68% depending on the example. O2TR barrier is also very good due to the PHAE layer. Good transparency is also maintained by the low haze value.

In Table 2, the Examples and Comparative Examples are tested for wetting tension, printability, and coefficient of friction (COF) of the side designated for printing, lamination, or coating (aka “A-side”). This “A-side” has also been corona discharge-treated. The side opposite the “A-side” was also tested for COF and is typically an untreated heat sealable resin layer containing antiblock (aka “B-side”). No slip agents are used in the Examples or Comparative Examples.

CEx. 1 through CEx. 4 in Table 2 show excellent wetting tension of >40 dyne/cm, excellent printability of >3.0 rating, but relatively high COF values on both the A and B-sides. This high COF on both sides of the film structure are due to the lack of any slip agents to improve the slipperiness of the film.

Table 2 CEx. 5, however, which uses F-T wax in the core layer for barrier improvement, shows a significantly lower surface energy of 38 dyne/cm, poorer printability of 2.5 rating, and significantly lower COF values on both the A and B-sides. These changes in properties are due to the migration of the F-T wax to the surfaces of both the A and B-sides. The wax is acting like a slip agent or lubricating agent, thus making the film slipperier. It is also reducing the wetting tension of the treated A-side surface and consequently, degrading printability.

Table 2 Ex. 1 and Ex. 2, which also contain F-T wax blend in the core layer for MVTR barrier improvement, in contrast to CEx. 5, does not show a loss of wetting tension on the A-side, nor is A-side printability degraded, and A-side COF is high, similar to that of the Comparative Examples that do not contain F-T wax. These results mean that the F-T wax did not migrate to the surface of the A-side and cause poorer wetting tension and printability. The polar PHAE coating acts as a barrier to the migration of the non-polar wax and thus, prevents degradation of printability and thus, plate-out of wax from that surface. However, B-side COF of Ex. 1 and Ex. 2 are very low, indicating that the wax did migrate to the surface of the B-side and continues to act as a slip agent, lowering COF of the B-side. Thus, in the absence of the polar PHAE coating on the B-side of these two examples, there is no impediment to wax migration to the B-side surface.

Thus, there has been found a solution to provide significantly improved transparent barrier films utilizing F-T waxes from 3 to 15 wt % loadings by weight of an HCPP core and an optional amount of up to 20 wt % of HCR masterbatch loadings in the core layer, combined with a PHAE layer as a surface layer which maintains high wetting tension properties and printability properties with substantially no wax migration to the surface.

### Test Methods

The various properties in the above examples were measured by the following methods:

Oxygen transmission rate of the film was measured by using a Mocon OXTRAN 2/20 unit substantially in accordance with ASTM D3985. In general, the preferred value was an average value equal to or less than 15.5 cc/m²/day with a maximum of 46.5 cc/m²/day.

Moisture transmission rate of the film was measured by using a Mocon PERMATRAN 3/31 unit measured substantially in accordance with ASTM F1249. In general, the preferred value was an average value equal to or less than 0.155 g/m²/day with a maximum of 0.49 g/m²/day.

Haze of the film was measured using a Gardner Instruments “HAZE-GARD PLUS” haze meter substantially in accordance with ASTM D1003. Desired haze value for a single sheet of film was 3% or less.

Wetting tension of the surfaces of interest was measured substantially in accordance with ASTM D2578-67. In general, the preferred value was equal to or greater than 40 dyne/cm.

Printability was rated qualitatively using a ranking system of 1.0-5.0, with 1.0 equating to very poor printability and 5.0 equating to excellent printability. 8½″×11″ cut sheet samples of the films were coated via hand drawdowns using a #4 Meyer rod on the side of interest with ca. ½ teaspoon ink (CC-ST 62 white ink from Toyo Ink), dried at 60° C. for 60 seconds in an oven, and tested for ink adhesion using a tape test. A strip of 24 mm wide adhesive cellophane tape is adhered to the non-inked side; a strip of 12 mm wide adhesive cellophane tape (e.g. 3M 610 tape) is adhered to the inked side corresponding to the area covered by the 24 mm tape on the un-inked side, and peeled off quickly, keeping the hand parallel to the film sample. The amount of ink remaining on the peeled surface of the film sample is then rated as follows:

1.0=75% removal of ink

2.0=50% removal of ink

3.0=25% removal of ink

4.0=10% removal of ink

5.0=0% removal of ink

In general, preferred value for printability is 3.0 minimum.

This application discloses several numerical ranges in the text and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

We claim:

1. A laminate film comprising:
a polyolefin base layer comprising a Fischer-Tropsch wax and a high crystalline propylene homopolymer of at least 95% isotactic index; and
a polar polymer layer.

2. The laminate film of claim 1, wherein the polar polymer layer comprises polyetheramine.

3. The laminate film of claim 1, wherein the film comprises at least 3% wt of Fischer-Tropsch wax.

4. The laminate film of claim 1, wherein the polyolefin base layer further comprises up to 10 wt % of a hydrocarbon resin.

5. The laminate film of claim 1, further comprising a polyolefin tie layer between the polyolefin base layer and the polar polymer layer.

6. The laminate film of claim 1, further comprising a polyolefin heat sealable layer, winding layer, adhesion layer, or printing layer.

7. The laminate film of claim 1, wherein the polar polymer layer is directly on the surface of the base layer.

8. The laminate film of claim 1, wherein the film is biaxially oriented.

9. A laminate film comprising:
a polyolefin base layer comprising a Fischer-Tropsch wax; and
a polar polymer layer comprising polyetheramine.

10. The laminate film of claim 9, wherein the polyolefin base layer further comprises a high crystalline propylene homopolymer of at least 95% isotactic index.

11. The laminate film of claim 9, wherein the film comprises at least 3% wt of Fischer-Tropsch wax.

12. The laminate film of claim 9, wherein the polyolefin base layer further comprises up to 10 wt % of a hydrocarbon resin.

13. The laminate film of claim 9, further comprising a polyolefin tie layer between the polyolefin base layer and the polar polymer layer.

14. The laminate film of claim 9, further comprising a polyolefin heat sealable layer, winding layer, adhesion layer, or printing layer.

15. The laminate film of claim 9, wherein the film is biaxially oriented.

16. A method of making a laminate film comprising:
co-extruding: a polyolefin base layer comprising a Fischer-Tropsch wax and a high crystalline propylene homopolymer of at least 95% isotactic index, and a polar polymer layer.

17. The method of claim 16, further comprising biaxially orienting the film.

18. The method of claim 16, wherein the polar layer comprises polyetheramine.

19. The method of claim 16, further comprising co-extruding a polyolefin tie-layer between the polyolefin base layer and the polar polymer layer.

20. The method of claim 16, wherein the film comprises at least 3% wt of Fischer-Tropsch wax.

21. The method of claim 16, wherein the polyolefin base layer further comprises up to 10 wt % of a hydrocarbon resin.

22. A method for flexible packaging comprising:
obtaining a laminate film comprising a polyolefin base layer comprising a Fischer-Tropsch wax and a high crystalline propylene homopolymer of at least 95% isotactic index and a polar polymer layer;
surrounding a product with the laminate film.
